(19) United States
(12) Patent Application Publication
(10) Pub. No.: US 2009/0186599 A1
(43) Pub. Date: Jul. 23, 2009

(54) Automatic Migration Of Prepaid Accounts For Wireless Communication Services

(76) Inventors: Dan Cipoletti, (US); Sherilyn Dwyer, (US); James Gamm, (US); Charles Seelig, (US)

Correspondence Address: FENWICK & WEST LLP, SILICON VALLEY CENTER, 801 CALIFORNIA STREET, MOUNTAIN VIEW, CA, 94041, US

(21) Appl. No.: 12/018,742

(22) Filed: Jan. 23, 2008

(51) Int. Cl. H04M 11/00

(52) U.S. Cl. 455/406

(57) ABSTRACT

Subscribers of a communication service may select from a number of bundled service plans, wherein a recurring charge is paid from prepaid accounts by the subscribers in exchange for a bundled package of services. The plans may further require subscribers to add a value to their prepaid accounts with a minimum frequency. If a subscriber fails to add value to the account within the required time period, the subscriber is automatically migrated to a different plan that includes fewer or no bundled services and may charge more per use of the services. If the subscriber subsequently adds sufficient funds to the account to satisfy the periodic payment requirement, the subscriber may be re-enrolled in that originally selected bundled service plan.

### BACKGROUND

1. Field of the Invention

This invention relates generally to communication services, such as prepaid wireless services, and more particularly to automatically adjusting the plan enrollment of a prepaid account for a subscriber of the communication service.

2. Background of the Invention

Many communication service providers—both wireless and wired—offer prepaid plans to their subscribers. But the way these plans are managed varies widely. When these plans are not managed effectively, profitability risks can be significant. Several service providers resort to price-only competitive strategies to attract new subscribers. For example, they may acquire new subscribers by offering price incentives such as free minutes or free or discounted handsets. This causes the service providers to bear new subscriber acquisition costs, which drives down the average revenue per unit of the subscriber base.

There is also a high churn rate associated with prepaid plans because service providers typically offer subscribers a limited set of plan options with very rigid rules. Often, these rules not only lock subscribers to a selected plan, but also penalize them for any payment defaults. The problem of high chum rate is compounded by the fact that several service providers only offer a single prepaid plan, which does not suit the needs of every new subscriber.

When a subscriber fails to pay the recurring charge for their prepaid account, and if the subscriber does not restore that account on time, service providers typically terminate the subscriber's service and cancel the subscriber's phone number. This may cause the subscriber to forfeit any balance money left in the prepaid account. Such an unfriendly attitude toward subscribers further alienates subscribers and discourages subscribers from signing on to the prepaid plan. In view of these deficiencies, flexibility in the choice of prepaid plans, as well as a more graceful handling of situations where subscribers fail to pay the charges on time, are needed to curb the high chum rates typically observed with subscribers of prepaid communication services.

Accordingly, there exists a need for a mechanism that allows subscribers of communication services to choose a suitable prepaid plan while avoiding the limitations of existing systems described above.

### SUMMARY OF THE INVENTION

To meet the needs of consumers as well as those of service providers, a billing system is configured to adjust a subscriber's prepaid account when the subscriber fails to meet certain minimum prepayment criteria. The adjustment to a subscriber's account may be to switch the subscriber's account from a more expensive option to a less expensive option, thereby enabling the subscriber to continue accessing the services. The less expensive option would typically include fewer communication services, but those services may be more expensive on a per-unit basis that the services in the more expensive option. For example, a more expensive option may include a larger number of bundled minutes of talk time, which costs more as a bundle but less on a per-minute basis. Essentially, the subscriber is buying fewer services but paying more for them on a per-unit basis. The additional profit on the services offsets the loss due to the lesser amount of services purchased. The subscriber thus continues to have access to the communications services, and the service provider is able to keep its customer.

In one type of prepaid account for wireless communications services, subscribers select from one or more bundled plans in which each subscriber prepays for a bundled set of services (e.g., minutes of talk time, kilobytes of data downloads, number of text messages, etc.) each month. The subscriber's account is debited each month to buy the bundle of services for the next month according to the subscriber's selected plan. The plans may also require a subscriber to add funds to the prepaid account within a given minimum frequency (e.g., at least once every 90 days), or the account is subject to cancellation. To avoid this, embodiments of the invention automatically migrate a subscriber's account to a different plan that includes fewer or no bundled services and that may charge more per use of the services. This allows the subscriber to continue using the services when the subscriber has failed to make a payment within the required time period.

In one embodiment, the service provider automatically cures the subscriber's account by returning it to the original status (i.e., the originally selected bundled plan) if the subscriber subsequently adds a sufficient value to the account.

These and other features, aspects, and advantages of various embodiments of the invention will become better understood with regard to the following description and accompanying drawings.

### BRIEF DESCRIPTION OF THE DRAWINGS

FIG. 1 is a schematic diagram of a wireless telephone services system, in accordance with an embodiment of the invention.

FIG. 2 shows a portion of a record in a subscriber database, in accordance with an embodiment of the invention.

FIG. 3 is a flow diagram of a process for automatically migrating a subscriber's prepaid account to a basic service plan, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

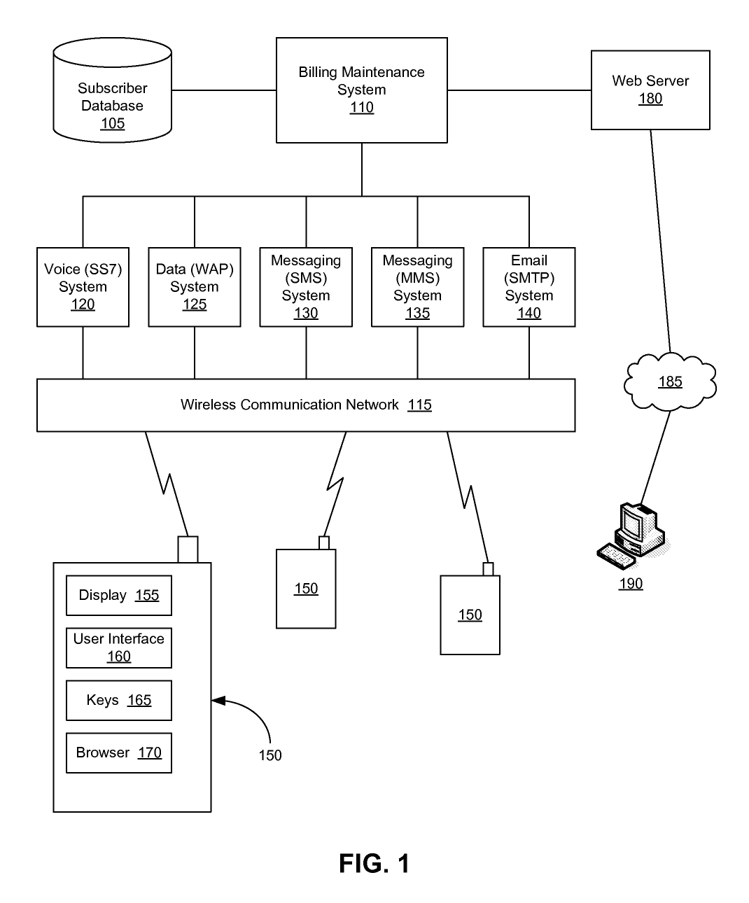

The automatic migration functionality described herein may be applied to many different types of telephone services, including both wired and wireless telephone services. Each of these types of telephone services may be implemented using a variety of hardware and software architectures. FIG. 1 shows one example of a system for providing wireless communication services; however, embodiments of the invention are not limited to this particular architecture or combination of wireless services shown, but rather they can be applied in many other environments. Accordingly, the architecture of a wireless services system is described herein to provide a context for an implementation of various embodiments of the methods and services described herein, but not to limit the applicability of those embodiments.

In a basic scenario, subscribers use their wireless mobile devices 150 to communicate with the services system via a wireless communications network 115. The wireless services system shown in FIG. 1 includes a number of subsystems that provide services for the subscribers. In this example, the subsystems include a voice system 120 to allow subscribers to make voice calls via the wireless network 115 and a data system 125 to allow subscribers to access digital information over the network 115 from their wireless devices 150. The wireless services system may further include subsystems such as a text messaging system 130, multimedia messaging system 135, and an email system 140, enabling subscribers to send various types of asynchronous messages over the network 115. These and other types of wireless services are well known.

The wireless service provider may track the subscribers' use of the services using a billing maintenance system 110. The billing maintenance system 110 typically comprises a computer system having software for managing the subscriber accounts for the wireless service. The billing maintenance system 110 is coupled to a subscriber database 105, which stores entries for the subscribers' accounts. In one illustrative example, the data associated with a subscriber's account includes a unique identification number (such as the phone number for the wireless device), a status for the subscriber's account (e.g., current, past due, suspended, or expired), an access code for validation of the subscriber, an account balance, and an optional expiration date of the account (defined below).

The billing maintenance system 110 is communicatively coupled to the services subsystems 120 through 140 to monitor their usage. In this way, the billing maintenance system 110 can record the transaction data for each subscriber in the subscriber database 105. The transaction data is an account of each subscriber's use of the services, which may for example include data such as the minutes and other details of voice calls, the amount of data sent and/or received in messages and emails, and the purchases of games or ring tones. As subscriber usage activity occurs, or periodically at other times, the billing maintenance system 110 adjusts the subscribers' account balances in the subscriber database 105 to debit the accounts for that usage as appropriate. The billing maintenance system 110 preferably also logs the usage activity in the subscriber database 105 so it can be later reported, for example, for billing or accounting purposes.

As shown in FIG. 1, the wireless devices 150 operated by the subscribers are configured to communicate wirelessly with the wireless communications network 115. Many types of wireless devices 150 exist, and other types will likely be developed in the future, but the devices 150 may comprise any products capable of communicating with the wireless network 115 described herein. This includes cellular phones, PDAs, handheld email devices, and similar devices.

In a typical embodiment, the wireless communication device 150 comprises a display 155, a user interface 160 for causing the display 155 to show content to a subscriber, and keys 165 to allow a subscriber to input controls and information. The keys 165 may include a first group of keys in the form of hard-coded keys (such as alphanumeric keys) and a second group of keys in the form of operation keys or “soft keys.” In one embodiment, the wireless device 150 further includes a browser 170 (such as a WAP browser or “minibrowser”) for viewing digital content encoded in a markup language.

The wireless service may be offered as a prepaid service, in which subscribers add value to their accounts before using the network. In one example of a prepaid service, the billing maintenance system 110 maintains the balance information for each of the subscribers, where the balance information includes an amount of value remaining in each subscriber's account. Based on pricing schemes defined by the service provider, a subscriber's usage of the network and/or other purchases associated with the subscriber's account causes a corresponding debiting of that account. The subscriber can continue to use the services while there is sufficient value in the account, after which the subscriber must add value to the account (also known as “topping up”). A variety of different payment methods may be used to replenish a prepaid account, including, without limitation, credit or debit card payments, direct payment from a checking account, and purchase and use of a PIN. Further, an expiration date may be set for each subscriber account, after which the account becomes inactive unless the subscriber adds value to the account. This date is typically set to be several months after the last time value was added to the account, or alternatively, after the last activity charged to the account.

In the context of a prepaid wireless services system shown in FIG. 1, and/or for other types of telephone services, a telephone service provider may offer a subscriber a choice among various payment plans. A subscriber may select one of many bundled service plans with each bundled service plan having a recurring charge associated with it for each payment cycle. The subscriber has several ways to choose a bundled service plan. For example, the web server 180 may receive a subscriber selection for a bundled service plan or for receiving payment to increase the subscriber's account balance. The web server 180 may be coupled to the billing maintenance system 110. Alternately, the subscriber may select a bundled service plan via the Internet 185, e.g., from a personal computer 190 that contacts the telephone service provider via the web server 180.

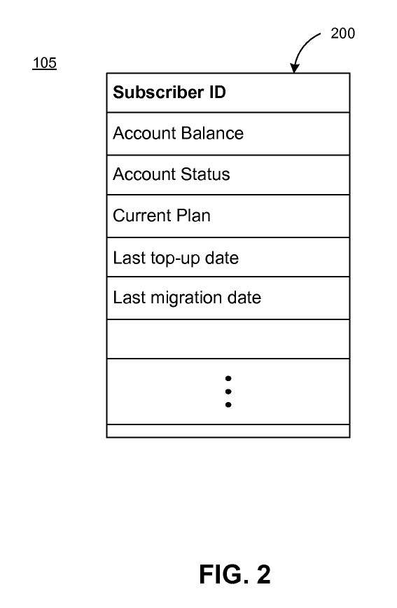

Once a subscriber selects a plan, the billing and maintenance system 110 stores this information in the subscriber database 105. FIG. 2 illustrates a sample record 200 in the subscriber database 105 for storing a subscriber's information. In the example shown, the data record 200 includes an account balance indicating the remaining balance for the subscriber's prepaid account; an account status indicating whether the account is active; a current service plan in which the subscriber is enrolled (e.g., a bundled plan or a basic service plan); a previous service plan indicating a previously selected plan (e.g., in the event the service provider automatically changes the subscriber's plan from the subscriber's originally selected plan); a last top-up date indicating when the subscriber last added value to the prepaid account; and a last migration date indicating when the subscriber's account was automatically migrated to a different plan.

The subscriber database 105 is updated in response to any events that trigger updates in of the records 200 associated with any subscriber. For example, a subscriber may enroll in a selected bundled service plan and then add value to the prepaid account. In such a case, the account balance is updated, the account status is updated if necessary, the current plan is set to the selected bundled service plan, and the last top-up date is set to the date on which the funds were added to the prepaid account. Subsequently, when the subscriber adds value to the prepaid account, the account balance is updated and the last top-up date is set to the date on which the funds were added to the prepaid account.

As mentioned above, the service provider may require that its subscribers add value to their accounts within minimum frequencies in order to keep their accounts active. For example, the service provider may require each subscriber to add at least $20 to the subscriber's accounts every 90 days; otherwise, the account is canceled or inactivated until the requisite amount is added. Periodically, the service provider, via the billing maintenance system 110, verifies that the subscribers have added the required value to their accounts. For example, if a subscriber's account record 200 indicates that the last top-up date is further out than the minimum period for adding value to the account, the service provider has determined that the minimum top-up rule has been violated.

But rather than inactive the subscriber's account, the service provider may change the subscriber's enrollment from the subscriber's current plan option to a different plan that includes fewer or no bundled services, and that may charge more per use of the services. The subscriber is then purchasing fewer services as a bundle but paying more for uses of those services.

In one embodiment, if the current plan field of the account record 200 indicates that the subscriber is enrolled in a bundled plan, the service provider automatically migrates the account to a basic service plan that includes no bundled services and charges more per use of the services than any of the bundled plans. Typically, because the services have not been pre-purchased for the given time period (e.g., month), the basic service plan offers the services at a higher use rate. If the subscriber is switched to the basic service plan, the billing maintenance system 110 begins to debit the subscriber's account based on the pricing scheme in the basic service plan. As long as the subscriber has some funds in the account, the subscriber can continue to use the services—albeit at a higher rate.

In one embodiment, the billing system 110 may allow the subscriber to cure the problem that lead to the automatic migration of the subscriber's account. For example, if the subscriber adds funds to the prepaid account in the next payment cycle, the account balance is updated and the last top-up date is set to the date the funds were added to the account. Because the last top-up date is now within the time period set by the service provider, the billing system 110 automatically switches the subscriber's account to the previously selected bundled plan.

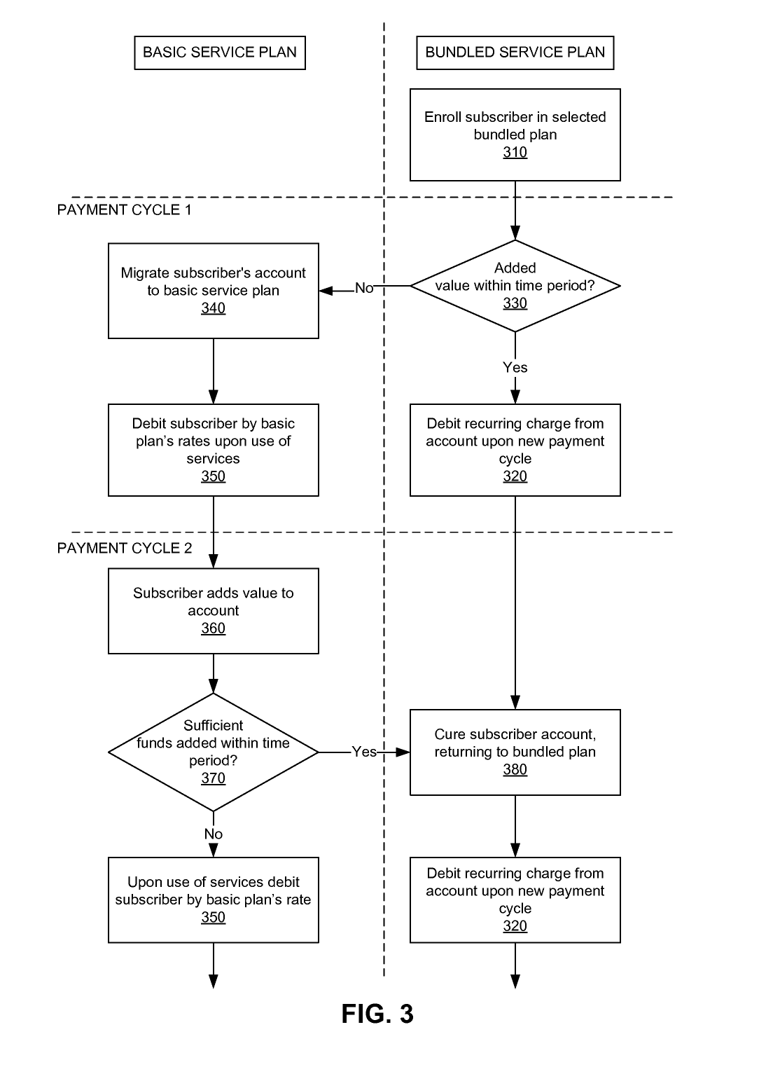

FIG. 3 is a flow diagram of a process for adjusting the status of a subscriber's prepaid account, in accordance with one embodiment of the invention. As illustrated, the subscriber is initially enrolled 310 to a selected bundled service plan. At the beginning of each payment cycle, the billing maintenance system 110 debits 320 from the subscriber's prepaid account the recurring charge that is associated with that selected bundled service plan.

At some point during the second payment cycle, the billing maintenance system 110 determines 330 whether the subscriber has added value to the account within the prescribed time period. If the subscriber has added value to the prepaid account within the required time period, the billing maintenance system 110 continues to debit 320 the subscriber's account by the recurring charge that is associated with the subscriber's selected bundled service plan. The subscriber thus receives the bundled services and any additional services according to the plan.

However, if the subscriber has not added value within the required time period, the billing system 110 automatically migrates 340 the subscriber's account to the basic service plan. In alternative embodiments, the migration may be to another bundled service plan, such as a less expensive plan that contains fewer bundled services but where the per-use rates for services are higher. Upon this automatic migration, the billing maintenance system 110 also updates the corresponding information in the subscriber database 105. Once the subscriber's account has been switched to the basic service plan, the billing maintenance system 110 debits 350 the subscriber's account by the basic rate as the subscriber uses the services. As mentioned, this rate may be higher than the effective rate for the bundled services.

In one embodiment, just as the system automatically migrates subscribers' accounts when they fail to make payments to their account within the required frequency, the system may also automatically cure the accounts if and when the subscribes eventually comply with the minimum top-up rule. Continuing the example shown in FIG. 3, after being migrated to the basic service plan, the subscriber at some point decides to add 360 value to the account. The billing maintenance system 110 then determines 370 whether the added amount is sufficient to comply with the minimum top-up rule. If it is sufficient, the system cures 380 the subscriber's account by changing it back to the previously selected bundled service plan. The billing system 100 then continues to debit 320 the account by the recurring charge associated with that bundled service plan. But if the amount added was not sufficient, the subscriber remains on the basic service plan, and the billing system 100 continues to debit 350 the subscriber's account by the basic rate as the subscriber uses the services.

In one embodiment, the service provider may also terminate the subscriber's account permanently if the subscriber does not add value to the account within a maximum allowed term. This allows a subscriber to continue using basic services for some amount of time, while requiring the subscriber to add value to the account eventually, even if beyond the requisite time period. This may help eliminate accounts in the system that are dormant or otherwise unused for very long periods of time.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for automatically switching the plan enrollment of a prepaid account for communication services, the method comprising:
maintaining a prepaid account for a subscriber of communication services, the prepaid account having an account balance to which the subscriber can add value;
offering a plurality of service plans to the subscriber, the service plans offering varying amounts of bundled services;
enrolling the subscriber in one of the service plans based on a selection received from the subscriber, the selected service plan being a bundled service plan debiting the subscriber's account by a recurring charge amount for each payment cycle in exchange for a bundled set of wireless communication services for the payment cycle; and
responsive to the subscriber's failing to add value to the prepaid account within a predetermined time period, switching the subscriber to a different one of the service plans that includes fewer or no bundled services than the selected service plan.

2. The method of claim 1, wherein the service plans comprise:
a basic service plan in which the subscriber's account is debited by a basic rate for the subscriber's use of the wireless communication services, and
a plurality of bundled service plans, each bundled service plan debiting the subscriber's account by a recurring charge amount for each payment cycle in exchange for a bundled set of wireless communication services for the payment cycle.

3. The method of claim 2, wherein the subscriber's account is switched to the basic service plan responsive to the subscriber's failing to add value to the prepaid account within a predetermined time period.

4. The method of claim 1, wherein the subscriber's account is switched to a service plan that charges more per use of the services responsive to the subscriber's failing to add value to the prepaid account within a predetermined time period.

5. The method of claim 1, wherein the predetermined time period is 90 days.

6. The method of claim 1, wherein the communication services comprises wireless communication services.

7. The method of claim 1, further comprising:
after switching the subscriber's account to the difference service plan, receiving a payment from the subscriber to add value to the account; and
switching the subscriber back to the service plan according to the subscriber's selection.

8. The method of claim 1, further comprising:
after switching the subscriber's account to the difference service plan, determining that the subscriber has not added value to the account within a second predetermined time period; and
responsive to the determining, terminating the subscriber's account.

9. A wireless communication services system for automatically switching the plan enrollment of prepaid accounts for wireless communication services, the system comprising:
a wireless communication network interface for allowing the subscribers of the wireless communication service provider to engage in wireless communications after enrolling in one of a plurality of service plans;
a subscriber database configured to maintain a prepaid account for each subscriber of the communication services, each prepaid account having an account balance to which the subscriber can add value; and
a billing maintenance system configured to receiving payments for the subscribers' accounts and to determine whether value has been added to the accounts within a predetermined time period, the billing maintenance system further configured to switch any subscriber accounts to which value has not been added within the predetermine time period to a different one of the service plans that includes fewer or no bundled services if the accounts.

10. The system of claim 9, wherein the wireless communication services comprise one or more of voice services, data services, and messaging services.

11. The system of claim 9, further comprising:
a web server for receiving payments from subscribers to add value to the subscribers' accounts.

12. The system of claim 9, wherein the service plans comprise:
a basic service plan in which the subscriber's account is debited by a basic rate for the subscriber's use of the wireless communication services, and
a plurality of bundled service plans, each bundled service plan debiting the subscriber's account by a recurring charge amount for each payment cycle in exchange for a bundled set of wireless communication services for the payment cycle.

13. The system of claim 12, wherein the billing maintenance system is configured to switch subscribers' accounts to the basic service plan responsive to the failing to add value to the prepaid account within a predetermined time period.

14. The system of claim 9, wherein the billing maintenance system is configured to switch subscribers' accounts to a service plan that charges more per use of the services responsive to the failing to add value to the prepaid account within a predetermined time period.

15. The system of claim 9, wherein the predetermined time period is 90 days.

16. The system of claim 9, wherein the billing maintenance system is further configured to switch a subscriber's account back to the subscriber's selected service plan upon receiving a payment from the subscriber to add value to the account.

17. The system of claim 9, wherein the billing maintenance system is further configured to terminate a subscriber's account after switching the subscriber's account to the difference service plan if the subscriber has not added value to the account within a second predetermined time period.
